(19) United States
(12) Patent Application Publication
(10) Pub. No.: US 2006/0043237 A1
(43) Pub. Date: Mar. 2, 2006

(54) Lighter, stronger landing gear legs for small airplanes

(76) Inventor: Clifford B. Cordy JR., Reno, NV (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/924,782

(22) Filed: Aug. 25, 2004

(51) Int. Cl. B64C 25/00

(52) U.S. Cl. 244/100 R

(57) ABSTRACT

Airplane gear legs must be strong, stiff, and capable of storing large amounts of energy. Present gear legs are very heavy. These improved gear legs use two composite materials. The first is very strong and flexible, allowing it to store a great deal of energy in a hard landing. These fibers are laid essentially parallel to the axis of the gear leg. The other fiber is very stiff, providing the torsional rigidity necessary to avoid flutter. The stiff fibers are laid at a large angle to the axis of the gear leg so their elastic limit is not exceeded during a hard landing.

### RELATED APPLICATIONS

NONE

### FEDERALLY SPONSORED RESEARCH OR DEVELOPMENT

NONE

### BACKGROUND

Pilots are known to make spectacularly bad landings. The landing gear of the airplane is expected to survive such landings. To do so, the landing gear must be extremely strong and somewhat flexible. The airplane has some gross weight. There is some rate of descent when contact (impact) is made with an unyielding surface (runway).

The product of gross weight and rate of descent (in appropriate units) is the energy that must be stored and/or dissipated by the landing gear. In general, dissipation elements are large, heavy, and not aerodynamic. Thus, in most cases the entire energy must be stored as elastic energy in some form of spring.

For the last 50 or 60 years, the landing gear for most small airplanes consisted of a rod made of spring steel, attached to the fuselage at one end and the wheel at the other end. Steel is very heavy, but it is cheap, it is stiff, and it will store more energy per unit weight than most other materials. Furthermore, if the plane is landed so hard that the elastic limit of the steel is exceeded, the steel will generally bend a long way before it breaks. This absorbs an enormous amount of energy, one time. Thus, the airplane may look strange while it taxies back to the hangar, but it does not become a pile of rubble on the runway.

Modern composite materials are much lighter than steel. Some, notably carbon, are stronger than steel (higher elastic limit), and much stronger per unit weight. But most are very stiff (have a high modulus of elasticity). The energy that can be stored per unit volume of material is proportional to the quotient of its elastic limit divided by its modulus of elasticity. Because of their lower density, some, such as carbon, will store more energy per unit weight than steel will, but the difference is not dramatic. Furthermore, when their elastic limits are exceeded, most composites will snap, not bend. If these materials are used in landing gear that is strong enough to survive a landing that will cause steel landing gear to limp back to the hangar at weird angles, their weight advantage over steel largely vanishes.

There are fibers, notably Kevlar, that have high yield strength and low modulus of elasticity. Landing gear made of Kevlar could survive an impact on landing with no structural damage that would leave steel landing gear weighing 10 times as much limping off the runway like a drunken sailor (or pilot). The reason this “obvious” solution is not used is that it causes another problem. Kevlar survives the impact because it is not stiff. Landing gear has to be stiff. If it is not stiff enough, the wheel, and wheel fairing, will flutter at high flight speeds. This will likely destroy the airplane. Flutter absolutely must be avoided.

### Improved Landing Gear Technology

Since multiple materials can be incorporated into a composite structure, it is possible to construct landing gear legs of multiple materials in such a way that landing impact energy is stored in a strong, flexible fiber while at the same time a strong, stiff fiber provides rigidity that eliminates flutter. Consider the two requirements in more detail.

Landing impact causes a unidirectional force on the landing gear, UP. The resulting flexure of the landing gear is UP This is resisted most effectively by incorporating a light, strong, flexible fiber as thick bands in the top and bottom of the gear leg, said fibers lying parallel to the axis of the gear leg. Of course, some additional structure must separate these bands so they act as a beam.

Flutter is an oscillation, generally perpendicular to the air flow, that is driven by an interaction between the air stream over the part in question, and the dynamic response of that part to the air flow. Generally, the part has some form of lift that changes with angle of attack and a mass that is not balanced around the axis of rotation of the part in question. In most cases, varying angle of attack plays a critical role in flutter. If the angle of the part cannot change, flutter cannot occur. Thus the gear leg must be stiff to prevent the wheel from fluttering. But, rotational stiffness is the primary requirement for avoiding flutter, and rotational stiffness has little effect on impact energy storage in a hard landing.

Rotational stiffness is maximized by using a fiber with a high modulus of elasticity, not necessarily exceptionally strong. This fiber is formed into a tube, ideally with a circular cross section. The fibers are laid into the surface at large angles to the axis of the tube, normally ±45°. In flutter, the initial driving force is typically small, and increases as the magnitude of the oscillation increases, until something is destroyed. If the part in question is sufficiently stiff to prevent flutter, it does not have to be very strong. Thus, modulus of elasticity is the primary consideration for these fibers.

For an effective gear leg, the two groups of fibers must be combined. The impact energy is stored in the flexible fibers running parallel to the axis of the gear leg (impact fibers, henceforth denoted “(I)”). The torsional rigidity is provided by the fibers laid on a diagonal to the axis of the gear leg (torsion fibers, henceforth denoted “(T)”). It is necessary to design the combination such that the maximum impact survivable by the impact fibers does not exceed the yield strength of the torsion fibers.

The maximum survivable elastic deformation of the impact fibers is proportional to their yield strength divided by their modulus of elasticity. If the wall of the gear leg is thin, the deformation of the torsion fibers is equal to the deformation of the impact fibers times the cosine of the angle between the torsion fibers and the axis of the gear leg. The maximum deformation these fibers can survive is proportional to their yield strength divided by their modulus of elasticity, and the constant of proportionality is the same as that for the impact fibers (because the maximum distance from the principal axis is the same for both). Now:
Deformation(I)=Yield(I)/Elasticity(I)
and:
Deformation(T)=Yield(T)/Elasticity(T)
while at the same time
Deformation(T)=Deformation(I)*cos ø
In order to prevent damaging the torsion fibers before damaging the impact fibers in a super hard landing,
cos ø≦Yield(T)/Yield(I)*Elasticity(I)/Elasticity(T)
Thus, for any combination of materials, it is easy to calculate a minimum allowable angle (maximum cosine of said angle) between the axis of the gear leg and the direction in which the torsion fibers are laid.

### SUMMARY

The problem of heavy landing gear is solved by making the gear legs of a composite structure of two or more materials. One material, or group of materials, uses fibers with high yield strength and low modulus of elasticity, said fibers running essentially parallel to the axis of the gear leg. These are built into a structure that is much stronger than the present steel gear legs used on airplanes of similar weight. In this case, “stronger” means that it will not break of suffer permanent deformation in an impact that would leave the steel landing gear seriously bent, permanently.

The second material, or group of materials, have moderate to high yield strength and high modulus of elasticity. These are incorporated into the matrix at angles far from the axis of the gear leg. These provide the torsional rigidity needed to suppress the tendency of the wheel and its fairing to flutter at high airplane speeds.

### BRIEF DESCRIPTION OF THE ILLUSTRATIONS

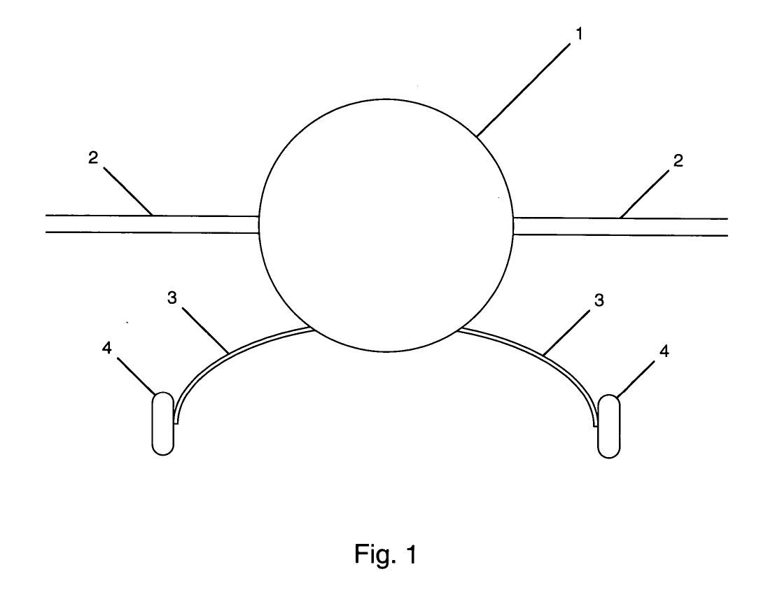

FIG. 1 is the front view of a generic airplane showing the landing gear legs.

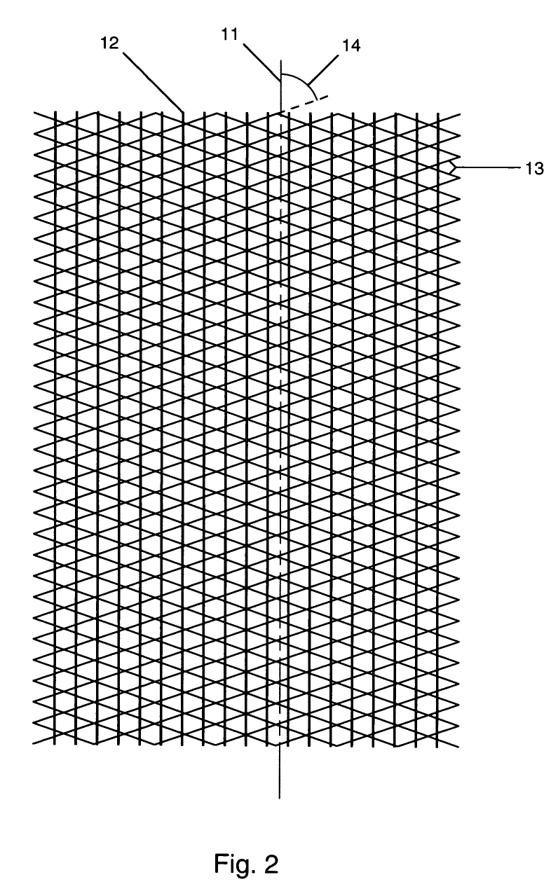

FIG. 2 is a detail of the lamination in the new, strong, lightweight gear leg.

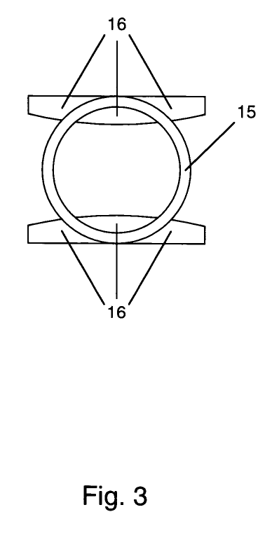

FIG. 3 is an end view of one possible configuration of the new gear leg showing the relative locations of the impact and torsion fibers.

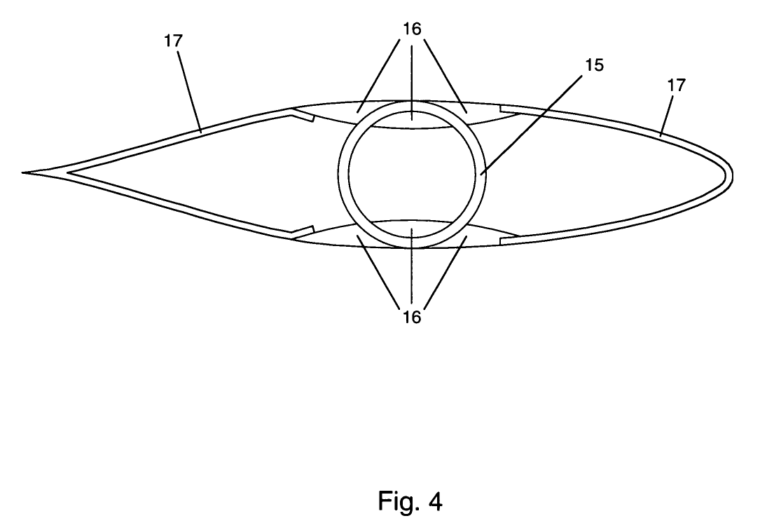

FIG. 4 is an end view of the new gear leg with one possible fairing added to minimize aerodynamic drag on the structure.

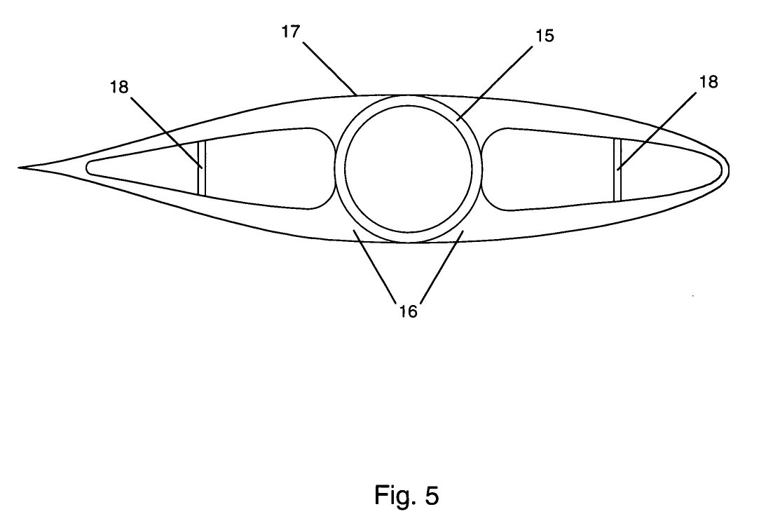

FIG. 5 is an end view of one possible gear leg that incorporates an aerodynamic shape into the gear leg itself.

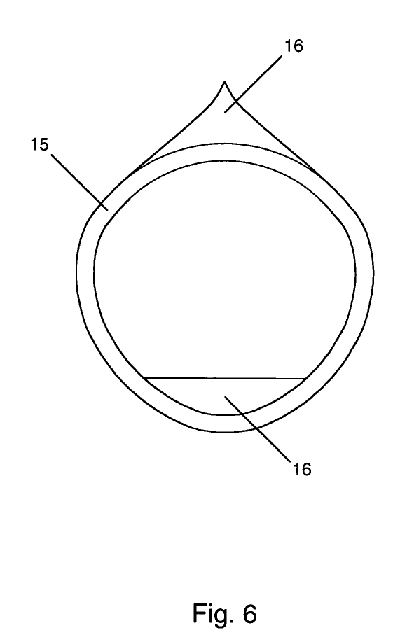

FIG. 6 is an end view of one possible gear leg for a tail wheel.

### DETAILED DESCRIPTION OF THIS INVENTION

In general, the main gear takes the brunt of the impact in a bad landing. Consequently, the drawings and commentary included here are primarily directed toward the application to main gear. However, pilots also manage to make colossal impacts with nose and tail wheels, and all descriptions herein are obviously usable in those applications too.

The front view of a generic airplane is shown in FIG. 1, with fuselage (1) and wings (2) sitting on gear legs (3). In FIG. 1, gear legs (3) are rigidly attached to fuselage (1) and to the axles (not shown) of wheel assemblies (4). It is common that gear legs (3) are individual units, each rigidly attached into the structure of fuselage (1). It is also common that gear legs (3) form a single beam between both wheel assemblies (4), with fuselage (1) perched in the middle of said beam. It is also common that gear legs (3) are firmly anchored into the structure of wings (2) rather than fuselage (1). It is also common that gear legs (3) are retractable into fuselage (1) and/or wings (2). Such details of mounting the gear legs to the airplane in no way affect the design described in this patent.

FIG. 2 shows the orientation of the fibers within a small section of the composite lamination. The strong, flexible impact fibers (12) are parallel to the axis (11) of the gear leg. The stiff torsion fibers (13) are at an angle (14) to the axis (11) of the gear leg. Angle (14) is the angle ø in the equations above.

There are many usable configurations for the construction of the gear leg. FIG. 3 shows one of them. In general the torsion fibers will form a torque tube (15), here shown as a circular tube, and the impact fibers will lie in bands toward the top and bottom of the torque tube (15) forming a beam (16). Beam (16) may lie entirely inside torque tube (15), entirely outside of it, or both inside and outside of it, as shown here. Torque tube (15) is not necessarily circular. It may be oval, rectangular, or an irregular shape, in order to conform to other constraints.

There is no need for the gear leg structure to be an aerodynamic cross section. It is a simple matter to make a fairing that will surround the gear leg. FIG. 4 shows a cross section of the gear leg of FIG. 3, slightly reshaped for aerodynamics, with fairing (17) added. The fairing may be one piece or multiple pieces. It may attach to the gear leg with fasteners, be part of the lamination of the gear leg, or be laminated to the gear leg after the leg is manufactured. Such details of a gear leg fairing, or lack thereof, in no way affect the design described in this patent.

In general, the torque tube will serve to maintain the necessary separation between the impact fibers to make them act as a beam. However, it is entirely possible to add one or more additional webs of material to make the beam stronger. FIG. 5 shows one such possibility. This is the end view of a gear leg formed as an aerodynamic unit, not needing a fairing. Torque tube (15) is formed first. A fairing (17) is formed over torque tube (15) with thick load carrying members (16) incorporated into fairing (17), with two additional webs (18) helping to maintain proper spacing between the main parts of beam (16). For any given impact strength, this configuration produces a smaller structure, with less drag, than the structure of FIG. 4, but it is more difficult to manufacture.

In a gear leg for a tail wheel, the top and bottom of the gear leg are at the ends of the chord of the gear leg, rather at the thickness of the gear leg. FIG. 6 is the end view of one possible gear leg for holding a tail wheel. Here a nearly circular torque tube (15) occupies a large fraction of the volume of the gear leg. This is shaped to form much of the airfoil of the tailwheel leg. Impact absorbing parts of beam (16) lie above and within torque tube (15) in such a position that the upper part of beam (16) itself completes the aerodynamic shape of the rear of the gear leg and lower part of beam (16) is entirely inside the airfoil shape of torque tube (15). In this end view, the gear leg appears unreasonably fat. However, the gear leg for the tail wheel typically is mounted 70° to 80° from vertical. As seen by the passing air, this shape has a chord to thickness ratio in the range of 5:1.

There are many other possible variations for the design and manufacture of composite gear legs employing separate materials for impact strength and torsional rigidity. All fall within the realm of this patent.

1. Composite gear legs for an airplane, said gear legs comprising at least two fiber materials, at least one one fiber material primarily employed to store the energy of a hard landing, at least one fiber material primarily employed to provide torsional stiffness in said gear legs.

2. Gear legs as in claim 1 employed to hold the main wheels of said airplane.

3. Gear legs as in claim 1 employed to hold the nose wheel of said airplane.

4. Gear legs as in claim 1 employed to hold the tail wheel of said airplane.
